(19) United States
(12) Patent Application Publication
(10) Pub. No.: US 2004/0230702 A1
(43) Pub. Date: Nov. 18, 2004

(54) Information processing device and method of program recovery

(76) Inventor: Motoyuki Sukigara, Suginami-ku (JP)

Correspondence Address: McIntyre-Lilley Intellectual, Property Management Services, Suite #12, 2000 South 2nd Street, Arlington, VA, 22204, US

(21) Appl. No.: 10/152,316

(22) Filed: May 22, 2002

(30) Foreign Application Priority Data
Jun. 8, 2001 (JP) 2001-173598

(51) Int. Cl. G06F 15/16

(52) U.S. Cl. 709/253

(57) ABSTRACT

A free area for recovery (unallocated area) 10d(2), an OS storage area 10d(1), and a user data area 10d(3) are provided on a hard disk 10d in a server device 10. Recovery OS data is written into the free area for recovery (unallocated area) 10d(2) in advance. When an error occurs in the OS, a user connects a serial dongle with a serial port to induce a short-circuit. When the server device 10 starts, a BIOS executes and detects that the serial port is short-circuited, the BIOS copies the recovery OS data stored in the free area 10d(2) into the OS storage area 10d(1) on the hard disk.

### TECHNICAL FIELD

The present invention relates to an information processing device, and specifically to the recovery of a program, such as an OS (Operating System), stored in an internal auxiliary storage device, such as a hard disk.

### BACKGROUND OF THE INVENTION

Servers which do not include a CD-ROM drive, a floppy disk drive, a video output, or a keyboard, and are managed through a network, such as a LAN or the Internet from a client PC have been recently proposed.

A general PC (Personal Computer) includes a CD-ROM and a floppy disk drive, when a server OS stored in a hard disk crashes, the reloading of the OS from these drives would permit the computer system to recover from such a failure.

However, when a server does not include a CD-ROM drive or a floppy disk drive, as described above, and only includes an internal storage device, such as a hard disk, if a server OS stored in a hard disk crashes, it is necessary to replace the hard disk itself, or to connect the hard disk to another PC to conduct a failure recovery process on this PC. The prior art problem of this failure recovery process is that it is difficult for a general user, and the operation is complicated, and takes time.

### SUMMARY OF THE INVENTION

The present invention was devised in view of the problems of the prior art and the purpose, thereof, is to provide an information processing device and a method for easily, and quickly recovering from a failure of a program, such as an OS, automatically.

To solve the above stated prior art problems, the present invention provides an information processing device comprising a ROM for storing a first program, an internal auxiliary storage device comprising a second program storage area for storing a second program and a recovery program storage area for storing recovery program data for the second program, a processing unit, and a bus for connecting the ROM, the internal auxiliary storage device and the processing unit to one another. The processing unit reads and executes the first program on the startup of the information processing device for detecting either one of a first state or a second state, reads and executes the second program when the first state is detected, and reads the recovery program data, and copies them to the second program storage area when the second state is detected.

It is preferable that the present device further comprises an input/output port connected to the bus where the processing unit reads and executes the first program to monitor the input/output port, and detects either one of the first state or the second state.

It is preferable that the processing unit detects: 1) whether specific terminals are short-circuited with each other in the input/output port, 2) the second state when they are short-circuited, and 3) the first state when they are not short-circuited.

The present invention provides a program recovery method for automatically recovering a second program for an information processing device comprising a ROM for storing a first program, an internal auxiliary storage device comprising a second program storage area for storing the second program, and a recovery program storage area for storing recovery program data for the second program, a processing unit, and a bus for connecting the ROM, the internal auxiliary storage device, and the processing unit to one another. The processing unit reads the first program at least to detect either one of a first state and a second state, to read and execute the second program when the first state is detected, and to read the recovery program data, and to copy them to the second program storage area when the second state is detected.

It is preferable that either one of the first state or the second state is detected based on a state of an input/output port connected to the bus in the present method.

It is preferable that the second state is detected when specific terminals are short-circuited in the input/output port, and the first state is detected when they are not short-circuited.

The present invention provides an information processing device comprising an input/output port, a means for detecting a short circuit between at least two terminals in the input/output port, and a processing means for executing a predetermined program recovery process when the short-circuit is detected.

In this way, the information processing device uses a first program (such as a BIOS) which is read from the ROM on computer system startup, and is executed on the processing unit in order to recognize either one of the first state (more specifically, a normal startup state) and the second state (more specifically, a failure recovery state) in the present invention. When the second state is recognized, the recovery process for a second program, such as an OS, is conducted. The following section describes the example for a BIOS, wherein a BIOS sequentially recognizes and initializes the hard disk and different types of input/output ports. If an OS error was detected on a previous startup, a user short-circuits between specific terminals in any one of the input/output ports, such as a serial port, the BIOS detects this short circuit on the next startup, and a failure recovery state is entered. When the failure recovery state is entered, the failure recovery program is copied to the second program storage area. As a specific method, recovery OS data stored in an area identified by logical block numbers stored in the BIOS in advance (the recovery program data storage area) is copied. As a result of this copy process, a normal OS exists in the internal auxiliary storage device, such as a hard disk, after the BIOS startup, and the information processing device operates normally.

The “internal auxiliary storage device” means a storage device other than one that can supply the information processing device with a program from the outside, such as a floppy disk or an optical disk (a CD and a DVD), and means a device stored in the information processing device. A typical example is an internal hard disk device. Because the area, which stores the recovery program data in an internal auxiliary storage device, is an area that is not used for normal system operation, it is preferable to set the area as an area, which the OS cannot recognize.

As described above, the present invention permits a server device to automatically recover from an OS error, by quickly and easily recovering a program, such as an OS.

### BRIEF DESCRIPTION OF THE DRAWINGS

FIG. 1 illustrates a diagram for a server device relating to an embodiment of the present invention.

FIG. 2 illustrates a front view and a rear view of a server device of an embodiment of the present invention.

FIG. 3 illustrates a network diagram of an embodiment of the present invention.

FIG. 4 illustrates a hard disk logical constitution drawing for a server device relating to an embodiment of the present invention.

FIG. 5 illustrates a BIOS process flowchart for a server device relating to an embodiment of the present invention.

### DETAILED DESCRIPTION OF THE PREFERRED EMBODIMENTS

The following section describes an embodiment of the present invention based on the accompanying figures, while exemplifying a server device as an information processing device.

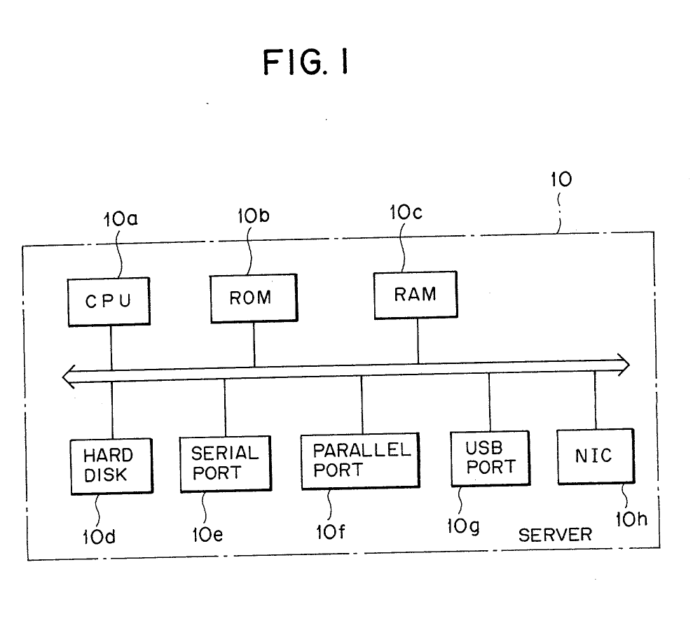

FIG. 1 shows a block diagram of a server device (or a server computer) relating to an embodiment.

The server device 10 comprises a CPU 10a, a ROM 10b where a BIOS program, and the like are stored, a RAM 10c, a hard disk 10d, a serial port 10e, a parallel port 10f, a USB port 10g, and an NIC 10h. Though this is almost similar to a general computer, it should be noted that there is no keyboard, interface for a mouse, video output, or CD-ROM drive (or a DVD drive), and consequently, neither a keyboard, a mouse, nor a display is connected. Because there are no keyboards or display, a network administrator does not have to operate a keyboard to specify IP addresses and other settings, as is the case for a conventional server device, and all settings are adjusted and directed through a client device (a client computer) connected with a network.

Linux, for example, is installed on the hard disk as an OS (Operating System) to start as a WWW server, and a CGI (Common Gateway Interface) is used for setting conditions from the client device.

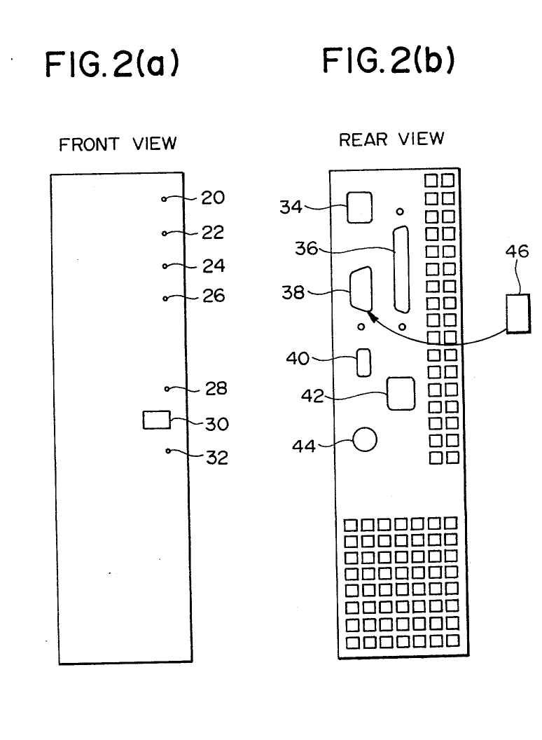

FIG. 2 shows an exterior of a server device 10 shown in FIG. 1. (a) is a front view and (b) is a rear view. A hard disk LED 20, a LAN LED 22, a status LED 24, an extended LAN LED 26, a power LED 28, a power switch 30, and a reset switch 32 are provided on a front face, and a LAN connector 34, a printer port 36, a serial port 38, a USB port 40, an extended LAN connector 42, and a power supply receptacle 44 are provided on a rear face. Connecting between the LAN connector 34 and a hub with a LAN cable (such as 10 BASE-T) physically establishes a connection with a network. Note that there is no port or connector for connecting with a keyboard, a mouse or a display, as shown in the rear view.

A serial dongle 46 for connecting with the serial port 38 is provided for the server device 10, and an user connects it to the serial port 38 (indicated by an arrow in the drawing) when the user determines that an error occurs in the OS. The serial port 38 has the well-known nine pins, and the serial dongle 46 is constructed for short-circuiting between Pin 2 (TxD: Transmit Data) and Pin 3 (RxD: Receive Data). Thus, detecting whether Pin 2 and Pin 3 are short-circuited in the serial port 38 detects whether or not the CPU of server device 10 is in the failure recovery state. This process is described later.

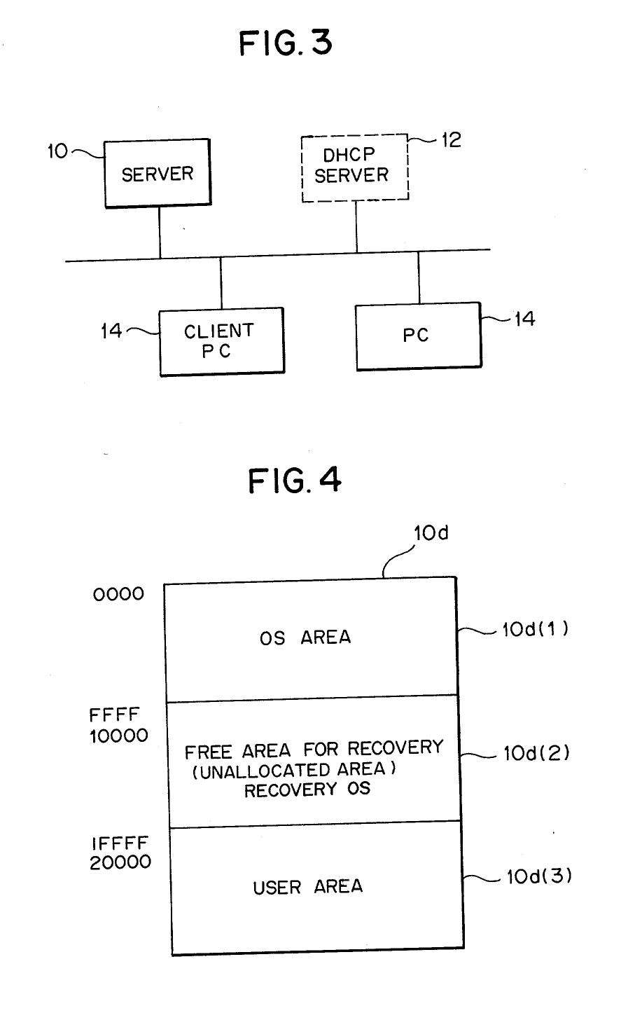

FIG. 3 shows a schematic network of a present embodiment. The server device 10 and client devices (client PC's) 14 are connected to the same network. When the server device 10 and the client devices 14 are connected through a hub, they are connected using a so-called star type connection. When the server device 10 and the client device 14 use TCP/IP protocol to communicate with each other, it is necessary to assign IP addresses to identify the individual computers. When there exists a DHCP server 12 on the network, the DHCP server 12 usually assigns devices connected with the network IP addresses dynamically. Namely, a set of IP addresses are reserved on the DHCP server for clients, an IP addresses is sequentially assigned on the startup of the client device, and the assigned IP address is recovered on the shutdown of the client device.

When the DHCP server 12 does not exist on the network, a network administrator, who has specialized knowledge, has to manually assign the individual device(s) IP addresses, and it is relatively difficult to correctly assign IP addresses without redundancy.

Even when the DHCP server 12 does not exist on the network, the client device 14 is used to simply assign to the server device 10 an IP address in a present embodiment. Specifically, software installed on the client device 14 starts to detect the existence of server device 10 based on a MAC address, and a ping command searches for a free IP address while sequentially changing an IP address. When a free IP address is found, the IP address is assigned as an IP address for the server device 10. Then, the WWW browser on the client device 14 is executed to set a name for the server device 10, and a permission for accessing.

In this way, though the server device 10 of the present invention does not have a keyboard, a display, or a drive for reading a medium for recording, a recovery OS can be connected to a network, and can function as a file server, it is impossible to use a recovery CD to recover the OS in the conventional case if an error occurs in the OS on the hard disk. Thus, the BIOS stored in the ROM automatically executes a recovery process on the server device 10.

FIG. 4 shows a logical constitution for a hard disk 10d on the server 10. The hard disk 10d is generally separated into three areas. Namely, there is an OS area 10d(1), a free area for recovery (unallocated area) 10d(2), and an user data area 10d(3). While the free area for recovery (unallocated area) 10d(2) is a free area inaccessible from the OS, and the capacity is approximately the same as that of the OS area 10d(1), the OS in a shipping state and related system software for the server device 10 are written in the free area for recovery (unallocated area) 10d(2), in advance. The logical block numbers for the free area (such as 10000 to 1FFFF) are written into the BIOS, and the BIOS uses data stored in this free area 10d(2) to recover the OS upon the occurrence of an OS error.

When multiple OS's are installed, free areas for recovery are formed corresponding to the individual OS areas, and recovery OS data is written. The hard disk 10d is partitioned, the OS is written into the OS area 10d(1), and the OS data are written into the recovery area 10d(2) upon shipping.

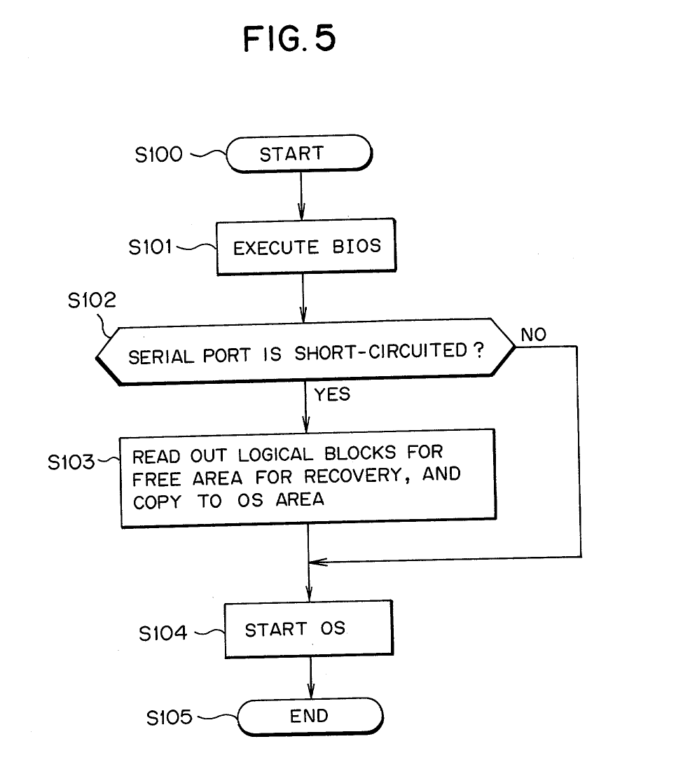

FIG. 5 shows a process flowchart for the automatic OS recovery by the BIOS.

When the server device 10 starts (S100), the BIOS (the first program) stored in the ROM is executed (S101). The BIOS correctly recognizes the hardware at individual parts/locations, and the OS (the second program) starts after the operation of hardware is confirmed. It is determined whether the serial port 38 is short-circuited during the execution of BIOS (S102). Specifically, predetermined data (such as a string, “TEAC”) is sent to the serial port in a predetermined time (such as one second), and data are received. When Pin 2 and Pin 3 are short-circuited by the serial dongle 46, the data transmitted through Pin 2, which is a data transmission line, is immediately received through Pin 3, which is a data reception line. When the serial dongle 46 is not connected, the transmitted data is not immediately received. In this way, it is determined whether Pin 2 and Pin 3 in the serial port 38 are short-circuited, and a normal operation state is detected to enter a normal OS startup operation when they are not short-circuited.

When they are short-circuited, it is determined that the BIOS is in a failure recovery state, the OS data stored in the free area for recovery (unallocated area) 10d(2) on the hard disk 10d are sequentially copied to the OS storage area by the logical block based on the logical block numbers for recovery free space stored in the BIOS in advance (S103). The status LED 24 is controlled to flash during the failure recovery process, and the status LED 24 is turned on, and the BIOS stops its operation on the completion of the failure recovery process. The user disconnects pulls off the serial dongle 46 from the serial port 38, and presses the reset switch 32, or operates the power switch 30 to restart the server device 10. Overwriting the OS storage area with the OS data in a shipping state makes the OS storage area store the OS in an initial state, and an MBR (Master Boot Record) in the OS storage area reads in a boot sector from a partition to be started to start the OS (S104).

In this way, because the serial dongle 46 is used to short-circuit the serial port of server device 10, the BIOS checks the status of the serial port before the startup of OS, the recovery OS stored in the hard disk, in advance, is copied if the serial port is short-circuited. Therefore, a user does not have to prepare a separate CD where the recovery OS is stored or to reinstall the OS. Thus, the system is recovered quickly and easily prior to the shutdown (S105) of the server device 10 in a present embodiment.

While the present embodiment exemplifies a case where the serial dongle 46 is connected to a serial port 38, it is possible to connect a predetermined connector to a parallel port, or to connect a predetermined connector to a USB port to set these ports to a predetermined state, and to make the BIOS detect an error of the OS. While the present embodiment exemplifies a hard disk as the internal auxiliary storage device, the present invention is not limited to a hard disk and is applied when a nonvolatile memory medium, such as a flash memory, is integrated and the OS is stored in it.

Those skilled in the art will recognize that the method and apparatus of the present invention has many applications, and that the present invention is not limited to the representative examples disclosed herein. Although illustrative, the embodiments disclosed herein have a wide range of modification, change and substitution that is intended and in some instances some features of the present invention may be employed without a corresponding use of the other features.

Moreover, the scope of the present invention covers conventionally known variations and modifications to the system components described herein, as would be known by those skilled in the art. Accordingly, it is appropriate that the appended claims be construed broadly and in a manner consistent with the scope of the invention.

What is claimed is:

1. An information processing device comprising:
a ROM for storing a first program;
an internal auxiliary storage device comprising a second program storage area for storing a second program, and a recovery program storage area for storing recovery program data for said second program;
a processing unit; and
a bus for connecting said ROM, said internal auxiliary storage device, and said processing unit to one another,
wherein said processing unit reads and executes said first program on a startup of said information processing device for detecting either one of a first state and a second state, reads and executes said second program when said first state is detected, and reads said recovery program data and copies it to said second program storage area when said second state is detected.

2. The information processing device according to claim 1, further comprising:
an input/output port connected with said bus wherein said processing unit reads and executes said first program to monitor said input/output port, and detects either one of said first state or said second state.

3. The information processing device according to claim 2, wherein said processing unit detects whether specific terminals are short-circuited with each other in said input/output port, detects said second state when they are short-circuited, and detects said first state when they are not short-circuited.

4. A method of program recovery for automatically recovering a second program for an information processing device comprising:
storing a first program;
storing said second program in an internal auxiliary storage device comprising a second program storage area;
storing recovery program data for said second program in a recovery program storage area; and
connecting a means for storing a first program, said internal auxiliary storage device, and a processing means to one another by a connecting means;
wherein said processing means reads said first program at least to detect either one of a first state or a second state, reads and executes said second program when said first state is detected, or reads said recovery program data, and copies it to said second program storage area when said second state is detected.

5. The method of program recovery according to claim 4, wherein either one of said first state or said second state is detected based on a predetermined state of an input/output port connected with said connecting means.

6. The method of program recovery according to claim 5, wherein said second state is detected when predetermined terminals are short-circuited in said input/output port, and said first state is detected when they are not short-circuited.

7. An information processing device comprising:
an input/output port;
a means for detecting a short circuit between at least two terminals in said input/output port; and
a processing means for executing a predetermined program recovery process when said short-circuit is detected.
